(19) United States
(12) Patent Application Publication
(10) Pub. No.: US 2003/0216843 A1
(43) Pub. Date: Nov. 20, 2003

(54) AirSafety system

(76) Inventors: Sinatra Frank Griffin JR., Park Forest, IL (US); Patricia Nichole Griffin, Park Forest, IL (US)

Correspondence Address: Patricia Griffin, 9 Mantua Court, Park Forest, IL, 60466, US

(21) Appl. No.: 10/394,081

(22) Filed: Mar. 21, 2003

Related U.S. Application Data
(60) Provisional application No. 60/367,256, filed on Mar. 25, 2002.

(51) Int. Cl. G05D 1/00

(52) U.S. Cl. 701/3; 701/9

(57) ABSTRACT

The AirSafety System supports the Department of Homeland Security, NTSB and FAA initiatives. Efforts to create an environment where accidents become ‘isolated occurrences’ are enhanced; and the opportunity for transportation to move forward is better attained. By way of advanced techniques, The AirSafety System gives governing entities the means to quickly determine each situation and respond accordingly. Communications are improved and the ability to control the aircraft is acquired.

### CROSS-REFERENCE TO RELATED APPLICATIONS

The AirSafety System was filed as a provisional Patent Application on Mar. 25, 2002; application No. 60/367,256; confirmation number 4340.

### STATEMENTS REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The AirSafety System pertains to the field of aviation involving the areas of operations, systems and safety. In cases of aviation accidents, the National Transportation Safety Board (NTSB) primarily use data transmitted from the flight data recorder and the cockpit voice recorder to determine the aircraft's parameters and conditions of the flight crew. According to the Chairman of NTSB, Jim Hall, the number of hours an investigator can spend per case is anywhere from 24 to 200 hours, depending on the complexity of the accident.

Further, Hall indicates that by the year 2003, the expected number of pilots flying in all aspects of aviation is 700,000; and the total number of hours per pilot is expected to reach 33 million.

The AirSafety System was created to support the National Transportation Safety Board, the Federal Aviation Administration, the Department of Homeland Security and other designated organizations to determine the cause of aviation accidents and assist in its prevention.

Using The AirSafety System will decrease time spent on caseloads; thus a focus on increased flight training and risk management can be utilized more effectively. It is intended to enhance current, established procedures to assist aviators and pioneer aviation security.

In addition, further emergencies subside with the use of the system through increased safety measures. The AirSafety System gives designated entities better control, when the aviator is found in urgent circumstances.

### BRIEF SUMMARY OF THE INVENTION

One of the most devastating occurrences is to have an aircraft in an urgent situation and there is nothing that can be done. Further, not being able to know what's going on—inside the plane—increases that sense of helplessness. The AirSafety System changes that. Knowledge of the conditions of the plane is known before utilizing black boxes.

Active communication is enhanced with the use of The AirSafety System. It allows all designated entities to have enough time to react and appropriately respond to emergencies. An imminent diagnosis is available.

When an investigation is needed, designated organizations will be able to rely on video recordings of flight conditions, in addition to the data stored in the CSMU; thereby reducing hours spent on caseloads.

By allowing governing entities to become actively involved with the aviator, crew and passengers—the overall safety of the flight dramatically increases. Furthermore, designated entities have the opportunity to obtain more control of the aircraft, specifically when the aviator needs help.

### BRIEF DESCRIPTION OF THE SEVERAL VIEWS OF THE DRAWING

These drawings are but examples and are not intended to hinder the invention.

FIG. 1a. An emergency activator—side view A switch that is partially enclosed in a plastic cover. The cover flips up to allow easy access.

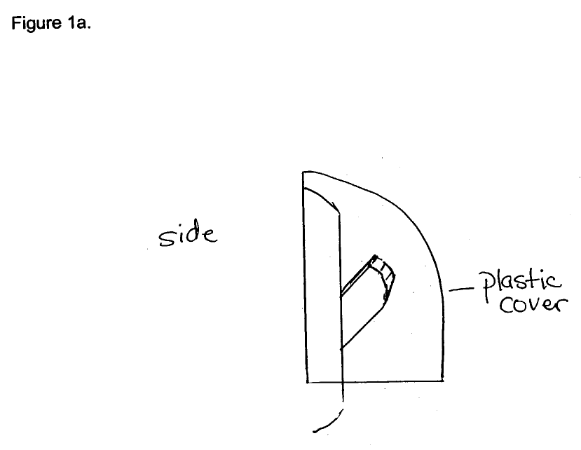

FIG. 2a. A camera with a dome shaped cover—front and side view. Inside the dome cover, the camera gradually moves horizontal then vertical—scanning and recording the aircraft.

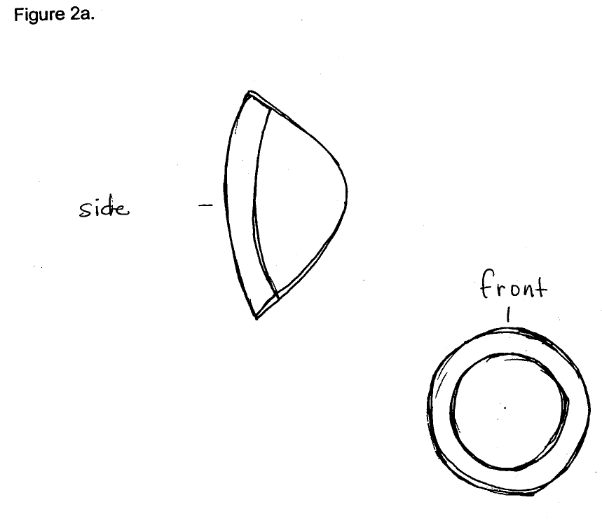

FIG. 3a. A typical cockpit where the emergency activator and camera may be stationed.

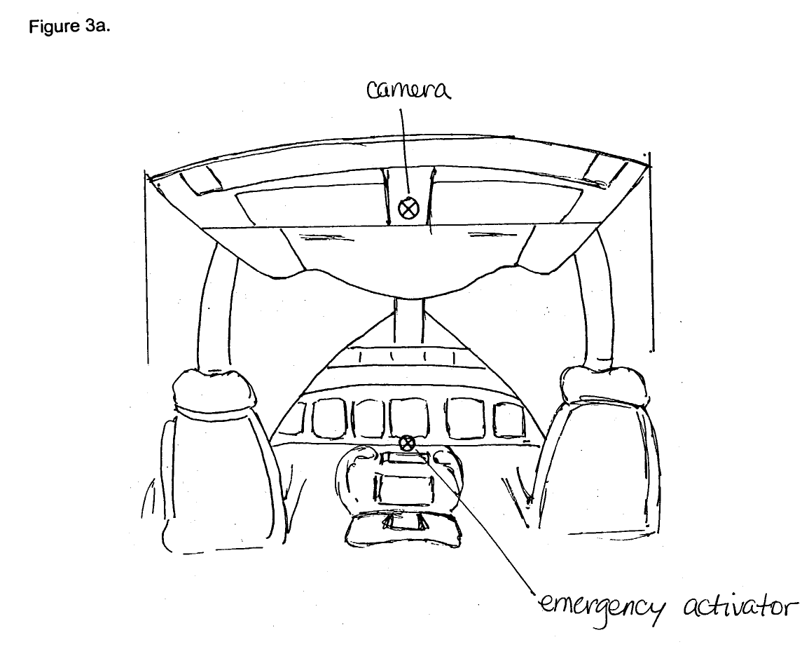

FIG. 4a. Seat map of an aircraft depicting where the cameras may be stationed.

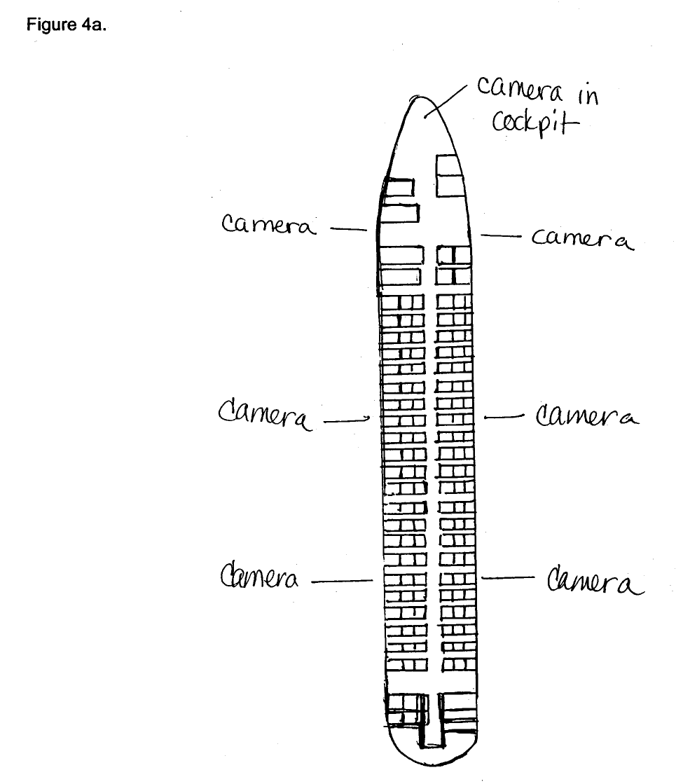

### DETAILED DESCRIPTION OF THE INVENTION

The governing entity will determine an area best suited to house The AirSafety System. Multi-screened monitors are used to observe specific flights at any given moment. Recorders are set up and established to keep an account of flight activity.

Cameras are installed in the aircraft and linked to its operating system. The total number of cameras is contingent upon the size of the aircraft. A basic criterion would be that one is positioned at a central location within the cockpit; and anywhere from 2-10 are strategically dispersed within the cabin. An emergency activator is also installed within the cockpit and at the rear of the cabin (for crew use).

During a crisis, an emergency activator is triggered by the aviator (or flight personnel). The activator triggers the cameras within the aircraft; hence, video images are scanned and concurrently recorded. In tandem, an electronic signal is sent to the designated governing entity, confirming the specific aircraft in difficulty.

Images are transmitted to a designated site via internet and satellite access, where the designated entity has full admittance.

An imminent diagnosis can be readily made through established systems (flight-plan information, profiles, radar data, controller-pilot radio transmission) and video surveillance.

Although notification of crises is initiated by the aviator, the designated entity has the option of triggering the surveillance of any aircraft using The AirSafety System, at any time.

At the discretion of the governing entity, the ability to override the aircraft's flight control system is obtainable. This process involves automatically controlling the flight to a path described by references internal or external to the aircraft. Telemetry and automatic flight control systems are combined to manipulate coordinates and control the aircraft with instruments stationed at designated locations.

The AirSafety System allows for several options:

Multi-screened monitors. With several screens made available, the governing entity can patrol various flight activity at the same time.

Video Surveillance. Although notification of crises is initiated by the aviator or flight crew, the designated entity has the option of triggering the surveillance of any aircraft using The AirSafety System, at any time.

Cameras. All governing entities can determine the logistics of camera placement and style: full scope lens with zoom capabilities; horizontal-then-vertical automatic movement; undetectable or conspicuous; and so on.

The designated entity will have two lines of defense with regard to risk management: designees will monitor various flights at any given time purposely preventing risk factor; and notification of emergencies are made with the aircraft itself (available for aviators and flight crew).

At any given situation, the designated entity can choose to manipulate flight coordinates or stall control systems (working with Homeland Security) until military personnel arrive.

With concerns surrounding cyberattacks and cyberwar, The AirSafety System can be operated by way of global broadcast or communications satellite where the system primarily relies on television signals transmitted from one point (aircraft) to another (designated entity location)—rather than a host internet site.

1. What we claim as our invention is the creation of an integration system, combining an emergency activator; horizontal-then-vertical scanning cameras; satellite-internet; and override of flight control systems within commercial or private aviation.

2. What we claim as our invention is the creation of an image-based surveillance system to improve imminent communication and investigation proceedings within commercial and private aircraft.

3. What we claim as our invention is the creation of an emergency activator, or similar thereof, for alerting governing entities of critical situations within commercial and private aircraft.
